(19) United States
(12) Patent Application Publication
(10) Pub. No.: US 2025/0176520 A1
(43) Pub. Date: Jun. 5, 2025

(54) Bout the IMPROVED TRACTION EQUINE SHOE

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 18/965,235

(22) Filed: Dec. 2, 2024

Related U.S. Application Data
(60) Provisional application No. 63/605,145, filed on Dec. 1, 2023.

(51) Int. Cl. A01L 3/04; A01L 5/00

(52) U.S. Cl. CPC A01L 3/04; A01L 5/00

(57) ABSTRACT

An equine shoe having one or more embedded bridges. Tee nuts are securely connected to the bridges, thus allowing for the durable connection of traction spikes to the shoe.

### CROSS-REFERENCE TO RELATED APPLICATIONS

This application claims the priority benefit of U.S. Provisional Application No. 63/605,145, filed Dec. 1, 2023, which is incorporated herein in its entirety.

### FIELD OF THE INVENTION

This patent application relates to equine shoes with improved traction and durability.

### BACKGROUND

Modern equine shoes are used to protect the hooves of horses and are often used in lieu of traditional steel or aluminum shoes. Such modern shoes typically includes a sole with a flat top surface that meets the underside of the hoof, as well as an upper part that projects upward from the sole and forms a peripheral enclosure for at least part of the hoof of the horse. A subset of modern shoes includes one or more traction spikes to improve traction in difficult conditions. Typically, the traction spikes in such shoes are removably screwed or otherwise securely seated into the sole of such shoes. FIG. 1 illustrates one exemplary, prior art equine shoe with T-nuts for receiving traction spikes.

While prior-art horseshoes with traction spikes have certain benefits and advantages over traditional shoe designs, they all suffer from significant shortcomings. One particular shortcoming relates to durability. That is, the traction spikes, and in turn, their securing mechanisms, are subjected to significant loads and high impacts during use. Over time, repeated high impacts can damage the spikes and/or their securing mechanisms. Eventually, the damage reaches a point where the spikes and/or their securing mechanisms fail and can be dislodged. Depending on the circumstances and terrain, upon failure or dislodging of a traction spike and/or the securing mechanism, the horse may lose traction. In any event, upon failure of these components, the shoe must be replaced.

What is needed, therefore, is an equine shoe that improves upon or resolves one or more of these drawbacks.

### SUMMARY

This application discloses a urethane horse shoe with embedded bridges, and tee nuts connected to such bridges. The tee nuts resist being dislodged under load, while securely retaining traction spikes.

### BRIEF DESCRIPTION OF DRAWINGS

Embodiments of the application will be described in detail in conjunction with FIGS. 1-13.

FIG. 1 is a perspective bottom view of a prior art equine shoe.

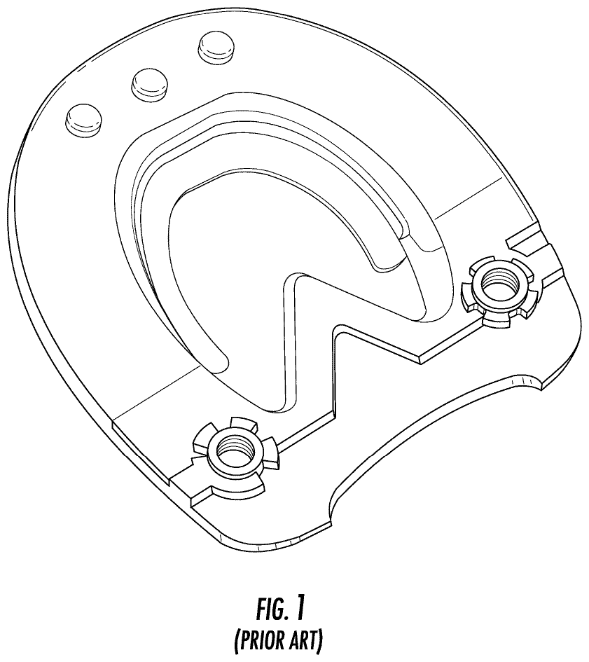

FIG. 2 is a perspective bottom view of an equine shoe sole according to the disclosure.

FIG. 3 is a bottom view of an equine shoe sole according to the disclosure.

FIG. 4 is a perspective top view of an equine shoe sole according to the disclosure.

FIG. 5 is a top view of an equine shoe sole according to the disclosure.

FIG. 6 is a perspective bottom view of an equine shoe according to the disclosure.

FIG. 7 is a perspective rear view of an equine shoe according to the disclosure.

FIG. 8 is a side view of an equine shoe according to the disclosure.

FIG. 9 a bottom view of an equine shoe according to the disclosure.

FIG. 10 is a top view of an equine shoe sole according to the disclosure.

FIG. 11 is a bottom view of an equine shoe sole according to the disclosure.

FIG. 12 is a bottom view of an equine shoe sole with traction spikes according to the disclosure.

FIG. 13 is a perspective side view of an equine shoe sole with traction spikes according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

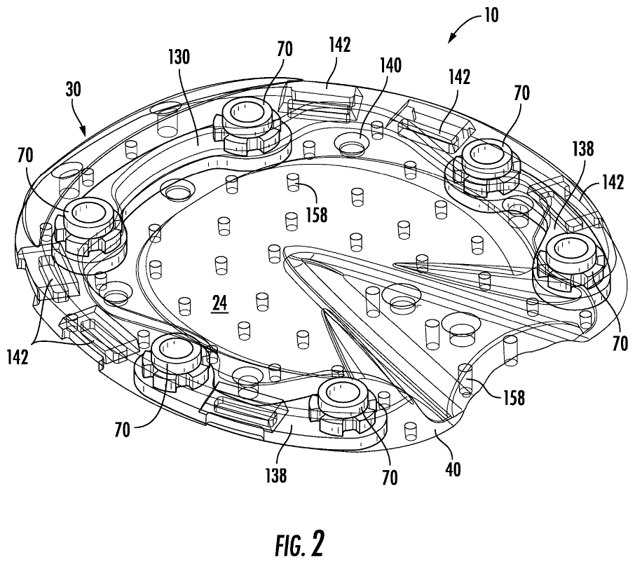

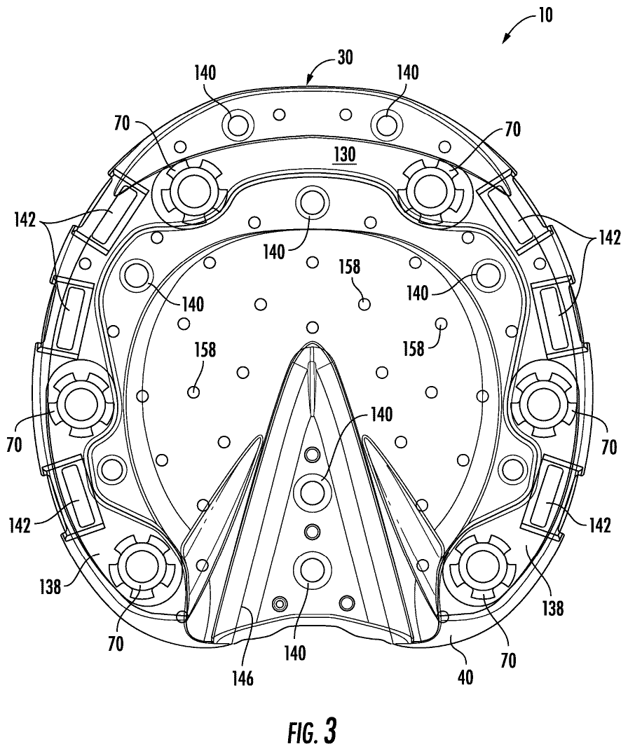

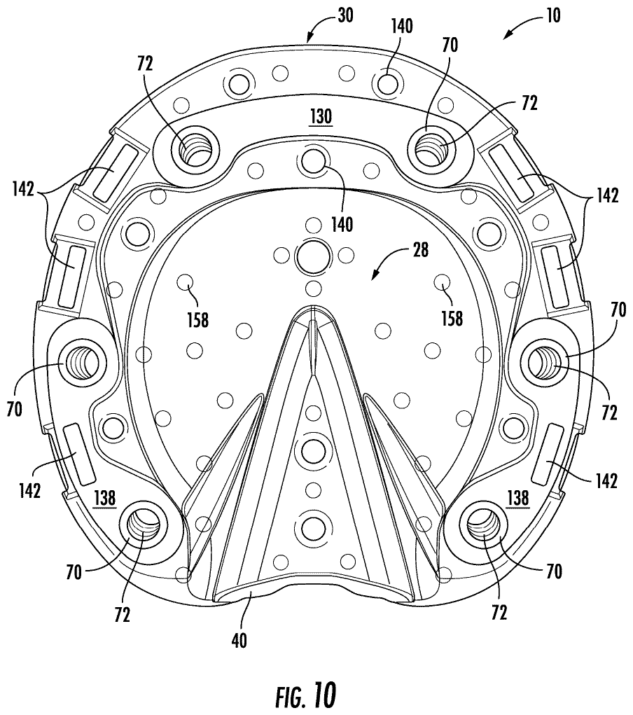

Embodiments of the present disclosure are best understood by referring to FIGS. 2-13 of the drawings, like numerals being used for like and corresponding parts of the various drawings.

### LIST OF REFERENCES

10 Shoe
20 Platform
24 Sole
28 Sole Superior Surface
30 Distal end
40 Proximal end
60 Lateral wall
70 Tee Nut
72 Thread
74 Traction Spike
80 Proximal Cutout
82 Distal Cutout
90 Passageways or Holes
120 Polymer Upper
124 Cuff
126 Singular Bridge
130 Distal Bridge
138 Lateral Bridge
140 Fenestration
142 Passageway
146 Frog Support
150 Ridge
158 Peg
160 Tread
162 Bottom
170 Superior end
180 Inferior end

Referring to FIGS. 2-13, shoe 10 has a platform 20 with a proximal end 40, a distal end 30, lateral walls 60 that extend from the platform 20, a superior end 170 and an inferior end 180. Shoe 10 includes a polymer upper 120 overmolded to a polymer sole 24. A distal bridge 130 and lateral bridges 138 are embedded in-whole or in-part in sole 24. Bridges 130 and 138 are provided with holes for receiving and securing tee nuts 70. The tee nuts are configured to removably receive and rigidly secure traction spikes 74. Additionally, both sole 24 and bridges 138 are provided with passageways 142.

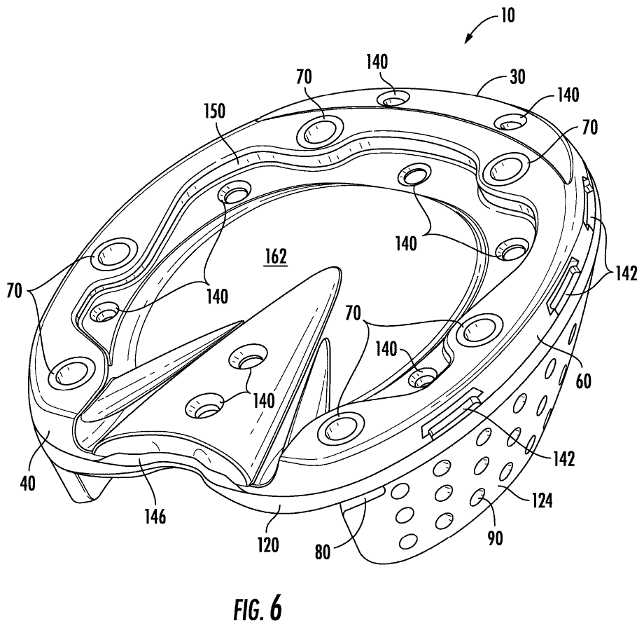

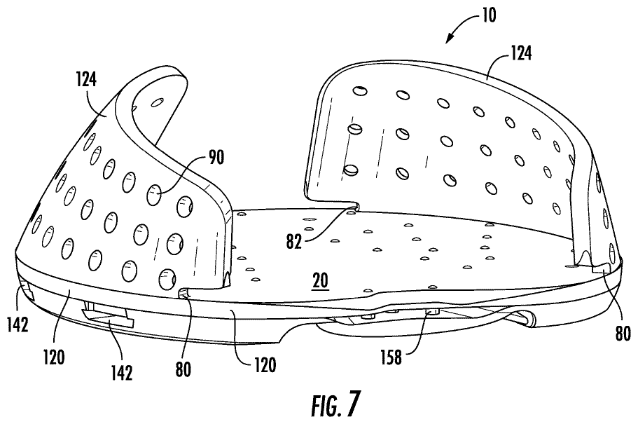

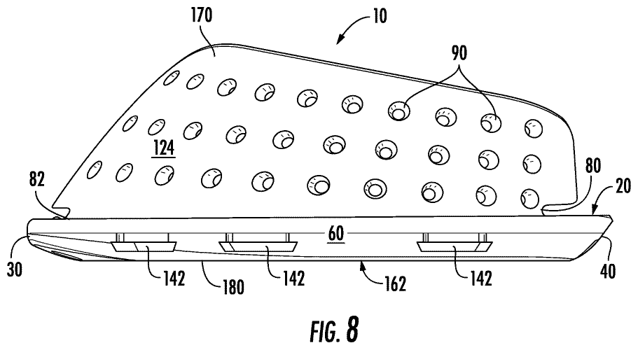

Platform 20 has a distal end 30 and a proximal end 40, as depicted in FIGS. 7-8, for example. The upper surface 154 is shaped to receive a horse hoof. To improve hoof traction on platform 20, an upper surface of the platform can be provided with a textured surface. Distal end 30 is shaped to receive the toe of a horse hoof. Proximal end 40 is sized to receive the heel of a horse hoof. As shown in FIGS. 6-7, the interior of the platform 20 is generally formed in the shape of a segmented arc that generally corresponds with the shape of a horse hoof, and a more flexible segment, frog support 146, to accommodate the expansion and contraction of the frog of the horse hoof. The quarters of the horse hoof is sized to fit between the proximal cutouts 80 and adjacent to the lateral walls 60.

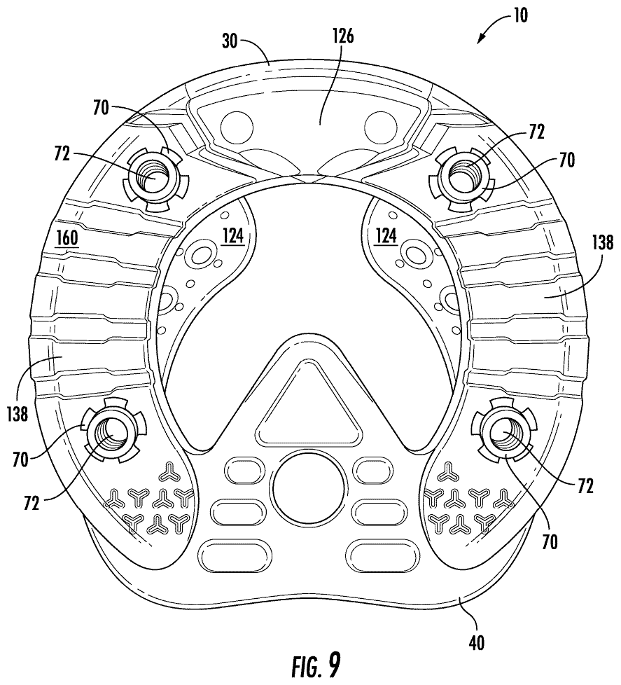

As best illustrated in FIGS. 2-5 and 10-11, shoe 10 includes a sole 24. Sole 24 provides a bottom surface 162 configured to protect a horse foot, while allowing the use of traction spikes for improved stability and grip in adverse or difficult conditions. Sole 24 is designed to cover and correspond with and naturally accommodate the weight bearing structures of a horse foot, i.e., the wall, sole and frog. In one alternative embodiment provided with treads 160, shown in FIG. 9, the upper 120 and sole 24 are provided with a central opening that generally corresponds with the sole of the horse foot.

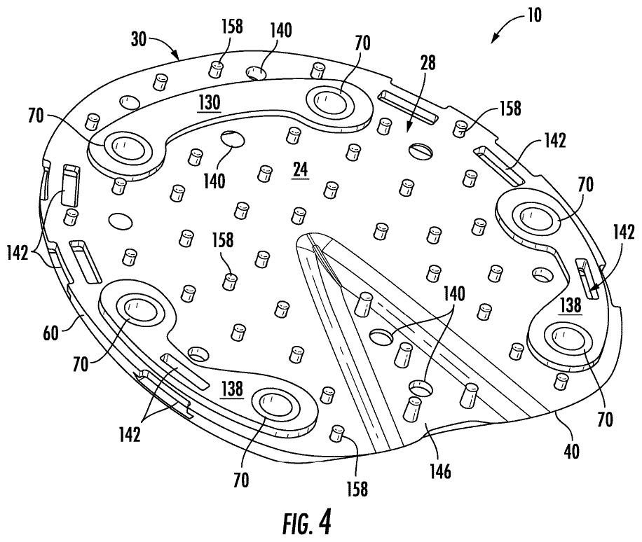

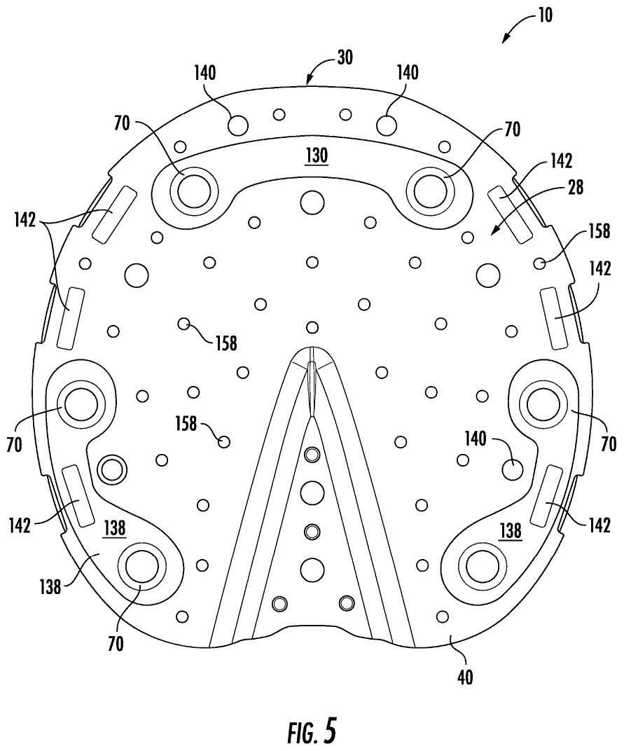

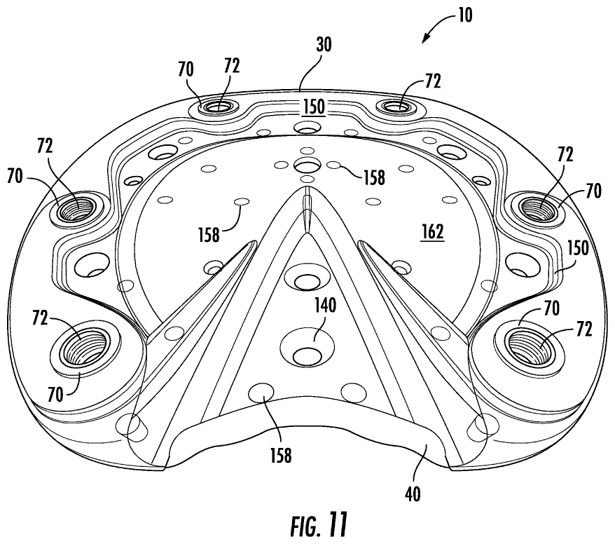

As shown in FIGS. 4-5, sole 24 has a superior surface 28 that has numerous pegs 158 extending therefrom. As shown in FIG. 7, pegs 158 are bonded to the polymer upper 120. Sole 24 also includes a plurality of holes or fenestrations 140, which securely bond the sole and the upper. Similarly, sole 24 includes a number of lateral passageways 142, which further bond the sole and the upper. Sole 24 also includes a bottom 162, which can be provided with treads 160 (FIG. 9) or an elevated ridge 150 (FIGS. 6 and 11). In one embodiment, ridge 150 is provided without an aggressive tread.

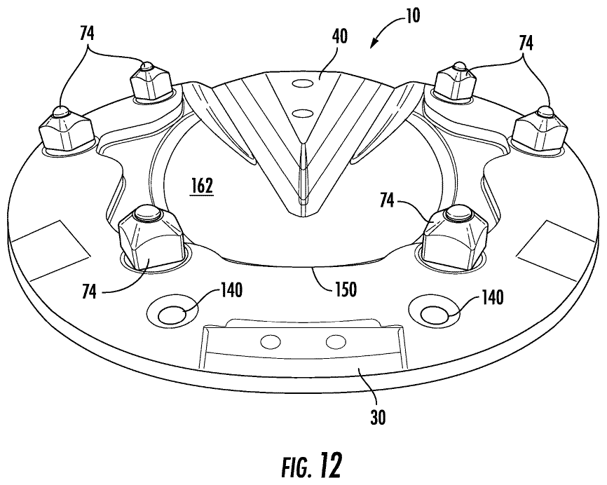

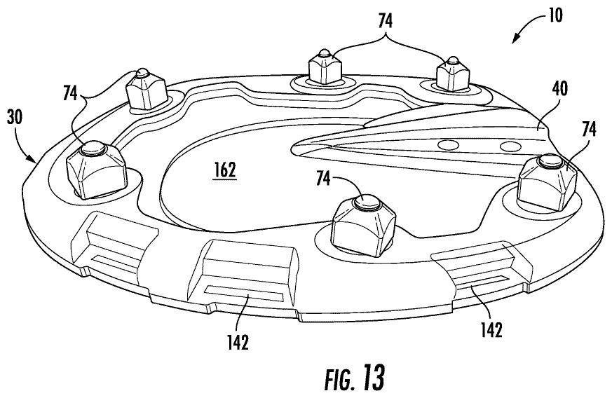

Referring to FIGS. 2-4, shoe 10 is provided with a distal bridge 130 and lateral bridges 138. Lateral bridges are securely embedded in the polymer material, and in particular, sole 24 of shoe 10. The bridges are preferably made of a metal or other rigid material, and can be provided with passageways 142 to improve bonding with the sole. Additionally, the bridges are provided with one or more holes for permanently and rigidly securing tee nuts 70 to shoe 10. As a result of their metal or rigid construction and design, the bridges prevent the tee nuts from readily loosening or becoming dislodged over time. Tee nuts 70 are preferably provided with threads 72 (FIGS. 9-11) to receive and secure threaded traction spikes 74 (FIGS. 12-13). In another embodiment, a singular bridge 126 is provided to add rigidity and further strengthen shoe 10. Bridge 126 is provided with one or more holes for permanently and rigidly securing tee nuts 70 to shoe 10.

Referring to FIGS. 7-8, cuffs 124 are provided with proximal cutouts 80 and distal cutouts 82. Such cutouts dramatically improves the fit and adherence of shoe 10 to the horse hoof. In particular, proximal cutout 80 improves fit on horse hooves and adherence to horse hooves by increasing the cuff surface area adhered to the hoof, while permitting additional hoof and shoe flexion without breaking the adhesive bond. Thus, when in use, proximal cutouts 80 and distal cutouts 82 allow for expansion and contraction, as well as growth of the horse hoof.

As depicted in FIG. 8, in one embodiment, lateral walls 60 form cuffs 124 having circular holes 90. Optionally, circular holes 90 can be utilized as holes for nails. The nails can be used to secure the cuffs 124 to the horse hoof. In one embodiment a glue is used to secure lateral walls 60 to the horse hoof.

In one embodiment the proximal end 40 of the shoe 10 is a material that can be shaved, such as urethane. This permits a user to precisely shave platform 20 to conform to the size and shape of the horse heel. The more precise proximal fit reduces the likelihood of the shoes interfering with a horse's gallop or other movement.

To fit the shoes 10, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods. For example, to ensure proper adhesion, the hoof can be roughed using a rasp or other appropriate tool and cleaned of dust, preferably three times.

An adhesive is then applied to the interior of lateral walls 60, as well as the horse hoof. The shoe is then pressed onto the hoof and wrapped with plastic wrap until an adhesive bond is formed, at which time the plastic wrap can be removed. Once adhered to the hoof, the proximal end of the platform can be shaved into a shape that corresponds with the horse hoof. The process is repeated for each hoof.

To manufacture shoe 10, the polymer upper and sole can be created from one or more aluminum blanks machined into the precise configurations shown FIGS. 2-13. Likewise, bridges 126, 130 and 138 can be machined with a properly configured CNC machine. Using an overmolding process, the urethane upper is bonded to the sole.

Depending on the intended use of the shoe 10, different durometer materials can be used for the upper and the sole. For example, in one embodiment, the material forming the sole can be made of a higher durometer than the material forming the upper.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. An equine shoe comprising:
a polymer upper portion;
a polymer sole joined to the upper portion; and
a proximal bridge embedded in the sole, the proximal bridge having a first tee nut, the first tee nut defining a passageway adapted to receive a traction spike.

2. The equine shoe of claim 1, further comprising:
a lateral bridge embedded in the sole;
the lateral bridge having a second tee nut, the second tee nut defining a passageway adapted to receive a traction spike.

3. The equine shoe of claim 2, further comprising:
a traction spike attached to to the proximal bridge.

4. The equine shoe of claim 3, further comprising:
a traction spike joined to the lateral bridge.

5. The equine shoe of claim 2, wherein the first tee nut has a threaded region adapted to threadedly engage a traction spike.

6. The equine shoe of claim 5, wherein the second tee nut has a threaded region adapted to threadedly engage a traction spike.

7. The equine shoe of claim 2, further comprising a first cuff extending from the polymer upper portion.

8. The equine shoe of claim 7, further comprising a second cuff extending from the polymer upper portion.

9. The equine shoe of claim 8, wherein the first and second cuffs each have a plurality of passageways.

10. The equine shoe of claim 8, wherein the first and second cuffs each include a proximal carveout.

11. The equine shoe of claim 8, wherein the first and second cuffs each have a distal carveout.

12. The equine shoe of claim 2, wherein the sole has a plurality of sole passageways extending through a periphery of the sole, and wherein the upper portion is bonded to such passageways.

13. The equine cuff of claim 12, wherein the sole has a plurality of pegs, the pegs extending the sole, and wherein the upper portion is bonded to such pegs.

14. The equine shoe of claim 2, wherein the sole has a frog support.

15. The equine shoe of claim 14, wherein the frog support has a frog support passageway.

16. The equine shoe of claim 2, wherein the lateral bridge has a lateral bridge passageway.

17. An equine shoe comprising:
a polymer upper portion;
a polymer sole bonded to the upper portion; and
a proximal bridge embedded in the sole,
a first threaded tee nut and a second threaded tee nut, the first and second tee nuts being attached to the proximal bridge;
a first lateral bridge embedded in the polymer sole;
a third threaded tee nut and a fourth threaded tee nut, the third and fourth nuts being attached to the first lateral bridge;
a second lateral bridge embedded in the polymer sole; and
a fifth threaded tee nut and a sixth threaded tee nut, the fifth and sixth nuts being attached to the second lateral bridge.

18. The equine shoe of claim 17, further comprising:
a traction spike threadedly engaged with one of the tee nuts.

19. The equine shoe of claim 18, further comprising a plurality of passageways through the sole and a plurality of pegs extending from the sole, the polymer upper being bonded through the plurality of passageways through the sole and to the pegs.

20. The equine shoe of claim 18, further comprising:
a first cuff extending from the polymer upper portion and a second cuff extending from the polymer upper portion.
